(19) United States
(12) Patent Application Publication
(10) Pub. No.: US 2026/0020699 A1
(43) Pub. Date: Jan. 22, 2026

(54) Wall mount for holding an object on a wal

(71) Applicant: David Thompson, Feuchtwangen (DE)

(72) Inventor: David Thompson, Feuchtwangen (DE)

(21) Appl. No.: 18/994,928

(22) PCT Filed: Jul. 14, 2023
(86) PCT No.: PCT/EP2023/069613

§ 371 Date: Jan. 15, 2025

(30) Foreign Application Priority Data
Jul. 15, 2022 (DE) 10 2022 117 758.0

(51) Int. Cl. A47G 1/20; A47G 1/17; F16B 45/00; F16M 13/02

(52) U.S. Cl. CPC A47G 1/205; A47G 1/17; F16M 13/02; F16B 45/00

(57) ABSTRACT

A wall mount for holding an object on a wall includes a main body having at least one securing structure for securing the wall mount to a wall, and at least two auxiliary bodies which are mounted movably on the main body and each have at least one holding structure for holding an object on the wall-securing mechanism, wherein the at least two holding structures are mounted on the main body via the auxiliary bodies so as to each be movable relative to the securing structure.

Corresponding wall mounts for holding an object on a wall are known in principle from the prior art. For example, it is known to secure a mirror or a picture by means of a nail or by means of a screw secured in a wall by a wall plug. For example, mirrors are secured to a wall by means of two fixing points, e.g. two screws. In order to be able to perform this securing for example in a tiled bathroom, usually a first screw can be inserted into the wall in a gap between two tiles. However, the second screw, owing to the fixed spacings for the screws specified by the object to be secured, usually requires drilling through a tile. This is associated with the risk of damage (e.g. cracking) of the tiles while drilling through them.

The object of the invention is that of specifying a wall mount which allows for simple and fast mounting of an object on a wall.

The object is achieved by a wall mount for holding an object on a wall according to claim 1. The claims dependent thereon relate to possible embodiments of the wall mount. The object is further achieved by an arrangement according to claim 13 and by a method according to claim 14.

The invention relates to a wall mount for holding an object on a wall, comprising (a) a main body having at least one securing structure for securing the wall mount to a wall, and (b) at least two auxiliary bodies which are movably mounted on the main body and which each comprise at least one holding structure for holding an object on a wall securing. In this case, the at least two holding structures are in each case mounted on the main body via the auxiliary bodies, so as to be movable relative to the securing structure. Preferably at least one auxiliary body, in particular all the auxiliary bodies, is/are mounted on the main body so as to be exclusively linearly movable. Owing to the movability of the auxiliary bodies on the main body, the holding structures arranged on the auxiliary bodies can be moved relative to the main body. In this case, the wall mount is constructed such that it is fixed to the wall at least in portions, preferably largely, particularly preferably exclusively, via the main body, and thus the bearing of the object takes place via the holding structure on the auxiliary bodies, and via the auxiliary bodies on the main body, and via the main body on the wall. In other words, the main body forms the, in particular only, interface between the wall mount, and preferably the object held on the wall mount, and the wall. The main body and the auxiliary bodies can be configured for example as rigid, i.e. not limp, elements. The main body and auxiliary bodies can thus be configured for example as rigid or dimensionally stable components. Since the components are configures as rigid or dimensionally stable components, the wall mount is insensitive to fluctuations, i.e. an airflow flowing past the wall mount cannot lead to a movement of the wall mount and/or of the object held on the wall mount. A rigid or dimensionally stable configuration of the components of the wall mount also makes it possible for the mounting of the wall mount and the mounting of the object on the wall mount to be simplified. The securing structure can be used for connecting the main body and/or the at least one auxiliary body to a wall in a force-fitting and/or form-fitting manner, and thus for example the securing structure can be configured as a lug for passing through a securing means.

The wall mount described herein allows for an object to be secured on a wall. In this case, the wall can form a room wall or a wall of any object, e.g. a wall of a cupboard, a bookshelf, or another item of furniture. The wall can also relate to a planar, at least substantially, preferably exclusively, vertically extending wall portion of a mobile object, e.g. a vehicle.

It is possible that at least one holding structure, in particular all the holding structures, of the wall mount is or are connected or connectable to the object by means of a force-fitting and/or form-fitting and/or integral connection. Thus, for example all the holding structures of the wall mount can be configured similarly or identically with respect to their interface to the auxiliary bodies and/or with respect to their interface to the object, such that each connection of a holding structure to the auxiliary bodies of the wall mount or each connection of a holding structure to the object is based on the same connection principle (e.g. force-fitting, form-fitting or integral) and/or has a similar or identical, i.e. e.g. a corresponding, geometry. The object can also be additionally or exclusively secured to the holding structure by means of magnetic forces.

It is possible that at least one holding structure, in particular all the holding structures, of the wall mount is or are configured as hook means for hooking into at least one hook receptacle of the object. Thus, for example an object can comprise at least two hook receptacles, into each of which, during operation of the wall mount as intended, a wall mount-side hook is hooked. The securing principle can also be provided in reverse at least in part, in particular completely, such that object-side hook means can be received in or are hooked into wall mount-side hook receptacles, i.e. e.g. that the wall mount comprises a hole or a recess for receiving a hook formed or arranged in or on the object. The holding structure can for example have a hook profile, e.g. a flat hook, which engages below a frame of an object to be secured to the wall, e.g. a stretcher frame. The holding structure can have a standardized configuration, such that objects adapted to said standardized configuration can be connected to the wall mount.

The at least one holding structure, in particular all the holding structures of the wall mount, can for example be detachably securable to the auxiliary bodies, or are secured thus. In this way, the holding structure, in particular a holding body encompassing the holding structure, can be detachably connectable or connected to the auxiliary bodies without tools and/or in a non-destructive manner. For example, the holding structure is formed as a protrusion, preferably as a hook, and is configured to come into engagement with a mating structure of the object. In this case, the holding structure can comprise a holding portion, for example provided with a hook, and a connecting portion that corresponds with the receptacle on the auxiliary body side.

The holding structure, i.e. a connecting portion of the holding body of the holding structure, can be able to be received in a receptacle on the auxiliary body side. The receptacle can be configured as a receiving shaft, in which the holding body comprising the holding structure can be received by a rotational and/or linear movement. An opening of the receptacle on the auxiliary body side preferably faces upwards or above a horizontal in an intermediate and/or final mounting state, such that the holding structure or holding body is received in the receptacles of the auxiliary bodies in an anti-loss manner and/or such that it cannot fall out, due to gravity, in the final mounting state of the wall mount. Advantageously, during hanging of an object on the holding structure, said structure is placed, on account of a tensile force acting on the wall mount on account of the dead load of the object, in an end position of the receptacle of the at least one auxiliary body that receives the holding structure, in such a way that unintentional movement of the holding structure out of the receptacle is prevented. In other words, by hanging the object a tensile force acts in the direction of the join direction of the holding structure, in a receptacle on the auxiliary body side.

It is possible for at least two groups of holding structures or two groups of holding bodies comprising different holding structures to be provided. This makes it possible for the type of holding of an object on a wall mount to be variable, in particular to be adjustable to the properties of the object, by alternately arranging the respective group of holding structures, in particular of holding bodies comprising different holding structures. For example, a first group of holding structures can comprise a first type of hook for holding a first object, and a second group of holding structures can comprise a second hook, different from the first type of hook, which are matched to holding a second object. The type of a hook of the respective group of holding structures can deviate in their material and/or their loading capacity and/or their geometric shape. The join direction or a main extension line of a movement path for securing a holding structure on or in an auxiliary body can for example be oriented at an angle of +/−90° to 0°, preferably of +/−45° to 0°, particularly preferably of +/−25° to 0°, relative to the movement direction of the auxiliary body. The join direction for the holding structures can for example form a joining movement that is at least in portions, preferably largely, particularly preferably entirely, non-linear relative to the respective auxiliary bodies.

It may prove to be expedient for at least one holding structure, in particular all the holding structures, to be connected in a latching manner to the auxiliary body, in particular to the respective auxiliary bodies. Thus, for example at least one holding structure, in particular all the holding structures, can be connected to the auxiliary body or bodies in a latching manner by the action of force. In particular, a latching may be made possible that provides a latching resistance which does not return, at least automatically, back into the basic state. In other words, at least two structural regions of holding structure and auxiliary body form a latching mechanism, such that in the case of action of force, which brings about a deformation of a deformation region, the at least two structural regions can be brought into engagement with one another in a form-fitting manner, for example in the manner of a latching, snap or clip connection.

It is possible for the at least two auxiliary bodies to be mounted in or on the main body so as to be, in particular exclusively, linearly movable. In other words, the auxiliary bodies are movably mounted in or on the main body in such a way that they perform a straight movement over their movement path, at least in portions, preferably largely, particularly preferably entirely. It is possible that, after the wall mount has been mounted on a wall as intended, in particular the main body has been mounted on a wall, the straight movement of the auxiliary bodies takes place in parallel with the horizontal. The main body can for example comprise guide means which, in particular exclusively, allow for linear mobility of the auxiliary bodies relative to the main body. For this purpose, the main body comprises for example guide rails for linearly movable mounting of the auxiliary bodies. It may prove to be expedient if, as well as the guide means, additionally a movement limitation device is provided, for example a pin is moved within a slot, wherein at least an end position of a pin/slot end contact brings about a movement limitation of the auxiliary body relative to the main body. A movement limitation device of this kind may optionally additionally have a function that assists the guidance of the auxiliary body and main body.

The position and/or orientation of at least one auxiliary body, preferably all of the auxiliary bodies, relative to the main body can be able to be displayed using a display device. A display device can e.g. comprise a scale, wherein the display takes place by reading off an item of display information or scale information that describes the position and/or orientation of at least one auxiliary body relative to the main body. For example, the scale can be read out in overview with a housing edge or a housing marking as a reference point. A scale can be formed in each case on both auxiliary bodies that are movably mounted on the main body, such that this allows for setting of a similar or an identical extract or a similar relative position of the two auxiliary bodies relative to the main body. This is advantageous in particular if a predefined relative positioning of the at least two holding structures for securing the object, to one another and a predefined setting to the at least one fixing point on the main body side to a wall is required or desirable for hanging an object.

The at least two auxiliary bodies can be coupled to the main body via a control mechanism, for example in such a way that the two auxiliary bodies assume a predefined position relative to the main body at least in portions, in particular completely, during their movement relative to the main body, in the manner of positive control. In this case, the positive control specifies defined positions of the two auxiliary bodies relative to the main body, in a manner positively controlled by a mechanism. In other words, the mechanism can achieve the positive control such that the spacings of the auxiliary bodies from a point of the main body change in a predefined ratio, in particular in a ratio that is unchanging or changes in a predefined manner, in the course of the movement of the auxiliary bodies relative to the main body. This prevents a first auxiliary body from having a first spacing from the main body, and a second auxiliary body from having a second spacing from the main body, which are not desired. The positive control mechanism prevents undesired ratios of the first to the second spacing. This can prove to be expedient in particular if the main body comprises at least one defined point, in particular exclusively one point, for connection to the wall, such that on account of the positive control, despite changing of the spacings between the auxiliary bodies and the securing point of the wall mount on the wall, and thus despite changing of the spacings of the holding structures from said securing point, an equilibrium can be retained at the securing point. Consequently, this makes it possible, in a simple manner, to change an adjustment of the spacing between the holding structures and the securing point of the main body to the wall, and at the same time to maintain or achieve an action of force of the object on the wall mount or on the securing point of the main body to the wall that is in equilibrium.

The control mechanism can for example control the mobility of the auxiliary bodies relative to the main body in such a way that a center of gravity of the wall mount based on a longitudinal extension of the wall mount changes by at most 15%, preferably at most 10%, particularly preferably at most 5%, most preferably does not change. In this way, a change in location of the center of gravity along the longitudinal extension can be prevented or kept to a limited amount despite a change in the spacing of the holding structures relative to the main body.

It is possible that at least one counterweight can be secured in its position and/or orientation in a variable manner on the wall mount. A counterweight can for example be an inertial mass which is secured to an auxiliary body and/or to a main body, in order to compensate a possible imbalance of an assembly formed by the object to be hung and the wall mount, relative to at least one, in particular to a single, securing point that secures the wall mount to a wall, preferably by means of a force-fitting and/or form-fitting connection. A counterweight can for example be connected in or to the wall mount and/or in or to an object to be hung, for example by means of a force-fitting and/or form-fitting and/or integral connection. The counterweight can for example be selected from a group of counterweights of different masses. It is possible that an item of scale information that can be read out at the wall mount, regarding the positioning of the at least one auxiliary body relative to the main body, can be linked to an item of selection information for selecting a defined counterweight for mounting on the wall mount and/or on the object to be carried by the wall mount. It can thus be provided for the scale information to display what counterweight from the group of counterweights of different masses is to be secured to the wall mount, and/or where on the wall mount.

The control mechanism can for example comprise a tooth flank surface on each of the auxiliary bodies, and a gearwheel that meshes with the tooth flank surfaces of the auxiliary bodies and is rotatably mounted on the main body. On account of the engagement of the gearwheel, which is in particular exclusively rotatably mounted relative to the main body, with the tooth flank surfaces of the auxiliary bodies, interpreting the configuration of the gearwheel and the tooth flank surfaces can allow for a predefined mobility of the auxiliary bodies relative to the main body. The tooth flank surfaces formed or arranged on the auxiliary body side can for example be configured as toothed rack-type elements, and thus have a straight main extension axis. Preferably, a first main extension axis of a tooth flank surface of a first auxiliary body is oriented in parallel with a second main extension axis of a tooth flank surface of a second auxiliary body. In this case, the zig-zag (upper) surface is meant by the tooth flank surface, which surface is formed by a plurality of teeth. It is possible that the gearwheel and/or at least one tooth flank surface is configured as an involute or cycloid or conchoid toothing.

The securing structure can be configured for example as an interface for securing the wall mount to a wall by a securing means, in particular by means of a nail or a screw. In this case, the securing structure can e.g. form a receiving channel or a lug for passing through a securing means, i.e. e.g. a nail or a screw, for securing the wall mount to the wall. In general, the securing structure on the wall mount side can allow for force-fitting and/or form-fitting and/or integral securing of the wall mount to a wall. It is thus possible for the securing structure to comprise a magnet or a magnetizable means, by means of which securing of the wall mount to the wall can be performed on account of magnetic forces. Alternatively or in addition, the securing structure on the wall mount side can be configured as suction means, e.g. as a suction cup, such that the wall mount can be pressed or secured to a smooth surface on account of negative pressure. This makes it possible to secure the main body to smooth tiles of a wall by means of suction cups, wherein the wall mount can form two object-side securing points to a wall at a single securing points, specifically the one suction cup of the main body to the wall.

Alternatively or in addition, the main body can be securable or secured by means of a hook-and-loop connection, i.e. the engagement of a hook-and-loop connection element (e.g. barb element) to a wall comprising a hook-and-loop connection mating part (e.g. loop mating element)

The securing structure can for example (a) be arranged and/or configured as an interface arranged or formed, in particular exclusively, centrally over the longitudinal extension of the main body, and/or (b) can be arranged or configured as interfaces, in particular exclusively, on both sides of a center of a longitudinal extension of the main body and having the same spacing from the center. It is possible for the securing structure of the main body to be configured in such a way that it is arranged or configured in the center of gravity relative to the main body and/or in the center of gravity of an assembly comprising the main body and the auxiliary bodies, or symmetrically to said center of gravity. A configuration arranged centrally with respect to the longitudinal extension makes it possible that, in the case of an interface comprising a plurality of securing points, said securing points extend on a vertical line, such that e.g. in the case of a securing of the wall mount on a backsplash the vertically extending securing points can be oriented so as to be flush with a gap of the backsplash.

It is possible for a clamping and/or latching means to be provided, which acts in a clamping or latching manner on a movement of at least one auxiliary body, in particular all the auxiliary bodies, relative to the main body. In this case, the latching mechanism can be configured, in particular exclusively, as a mechanism that acts directly between the two auxiliary bodies. For example, a latching finger formed on a first auxiliary body engages directly on a mating latching structure formed on the second auxiliary body. Alternatively or in addition, in order to form a clamping and/or latching device, a latching finger of a first auxiliary body can engage or act, in particular directly, on a tooth flank surface of the second auxiliary body and/or on a sprocket arranged between the two auxiliary bodies. In this way, in the case of engagement of the latching finger in the tooth flank surface, said tooth flank surface can assume a dual function, on the one hand as a component of a latching device, and on the other hand as a component of a positive movement mechanism.

In addition to the method, the invention also relates to an arrangement comprising a wall mount described herein and a levelling device described herein. In this case, the levelling device can comprise a connection interface, by means of which the levelling device can be connected to the wall mount in a predefined position and orientation relative to the wall mount, in particular in a force-fitting and/or form-fitting manner. The connection between the connection interface on the levelling device side and the wall mount can preferably be configured such that it can at least bear the dead load of the wall mount. In other words, it is possible to bear or hold the wall mount by holding the levelling device. Thus, by the holding of the levelling device the wall mount can be positioned and oriented in a comfortable manner on a wall, and optionally be held during a securing step for securing the wall mount to a wall. After the wall mount has been oriented and/or secured on the wall (e.g. after it has been screwed to the wall), the connection between the wall mount and the levelling device can be separated. Consequently, the levelling device is available for use for securing a further wall mount described herein.

In this case, the handling can be improved in that the levelling device comprises a handle that protrudes perpendicularly to its main extension plane. Holding the levelling device at this handle makes it possible for the levelling device, in the state when connected to the wall mount, for both the levelling device and the wall mount to be comfortably positioned and oriented on a wall. In particular, the one-handed operation of the holding of the wall mount and levelling device makes it possible for its orientation and a tracing of a marking on the wall (e.g. using a pin) taking place using the other hand, and/or the introduction, with the other hand, of a securing means, securing the wall mount to the wall, into the wall, to be carried out. The levelling device can for example comprise a level that is arranged or formed in or on the levelling device in a detachable or non-detachable manner.

The invention furthermore relates to a method for mounting an object on a wall using a wall mount described herein and/or using an arrangement described herein.

The main body can for example have a cuboid basic shape. The main extension axis of the main body can for example extend or be oriented in parallel with the main extension axis of at least one, in particular both, auxiliary bodies. The main body can for example describe or define a volume, wherein the auxiliary bodies are arranged having their longitudinal extension, in the contracted state, at least in portions, preferably largely, particularly preferably entirely, within the volume of the main body. The main body can for example be configured as a body comprising at least one wall that is closed at least in portions, in particular completely, or as a body comprising at least one wall that is grating-like at least in portions, preferably completely. Preferably all the walls of the main body are configured as closed walls or as grating-like walls.

End portions on the auxiliary body side can have a flush transition to the main body in their contracted state, at least at one surface, preferably at all the surfaces.

The main body can define a receiving space, within which the auxiliary body is received at least in portions, preferably a predominant portion of the auxiliary body. The main body can be of an elongate cuboid shape, wherein a first auxiliary body is arranged at a first end face of the main body and a second auxiliary body is arranged at an end face of the main body opposite the first end face of the main body. The auxiliary bodies can preferably be moved into or out of the receiving space of the main body through an opening of said receiving space associated with the respective end face. The end faces of the main body are for example the short side surfaces, which are oriented perpendicularly to the wall during securing of the main body to the wall as intended.

The main body and/or the auxiliary body can for example have a rectangular cross-sectional shape. The wall mount is for example configured or intended to be mounted on a substantially vertically oriented wall. The movement axes of the first and second auxiliary body can be oriented in parallel with one another. Preferably, the movement axes of the at least two auxiliary bodies coincide in their projection. It is possible for the movement axes of the at least two auxiliary bodies to coincide within space, i.e. viewed three-dimensionally.

It is possible that a holding structure-side connecting portion of at least one holding structure side is configured such that it can be inserted into the auxiliary body-side receptacle only in a predefined orientation. For this purpose, the connecting portion to be received in the receptacle can be of a conical shape or a shape that tapers towards its end facing the receptacle. For example, the connecting portion on the holding structure side is configured to be wedge-like or wedge-shaped. The receptacle can comprise an opening on two side surfaces, for example a first side opening serves for introduction of the holding structure-side connecting portion wherein a second opening (second side opening) extending laterally to the movement path for the introduction of the holding structure-side connecting portion serves for receiving the hook element arranged or formed on the connecting portion. In this case, the hook element engages through the second side opening during the movement of the holding structure into the auxiliary body-side receptacle.

It is possible for a holding structure-side hook element to be configured to be variable, in particular such that it can be set, in its extension perpendicularly to the main extension direction of the wall mount. Thus, the hook element can be configured depending on or in a manner adjusted to the configuration of the object, and thus be variable at least in its length perpendicularly to the main extension plane of the wall mount and/or perpendicularly to the main extension plane of the wall in the state when the wall mount is arranged as intended on the wall. For example, an adjustment to different widths of a picture frame, e.g. a stretcher frame, can take place.

It is possible that the securing structure comprises a single interface, in particular a single securing point, for securing the wall mount to a wall. This achieves the advantage that just one single fixing to the wall has to be performed. If for example the wall is provided with a backsplash, a single drilled hole, e.g. at an intersection point of the gaps of the backsplash, is sufficient for securing the object to the wall by means of the wall mount. It is thus possible for the wall mount to be connected or fixed to the wall by a single securing means, e.g. a screw and/or a nail and/or a suction cup.

The securing structure preferably comprises a single interface, in particular a single securing point, for securing the wall mount to a wall in a force-fitting and/or form-fitting manner. That is to say for example that the wall mount is secured to the wall mount via a single force-fitting and/or form-fitting connection or via a single securing point forming a force-fitting and/or form-fitting connection. Optionally, in addition to the single force-fitting and/or form-fitting connection, a further connection by means of an integral connection can be provided, e.g. by means of an adhesive. It is thus possible that, by means of the integral connection or by means of the adhesive, prefixing and/or anti-twist securing of the wall mount takes place, and the more loadable connection of the wall mount to the wall is achieved by means of the, in particular single, force-fitting and/or integral connection.

Alternatively to a single securing point, it can for example be provided for the securing structure to comprise at least two securing points or two securing interfaces for securing the wall mount to a wall, wherein the at least two securing points are located on a common straight line, wherein the line is oriented perpendicularly to a main extension axis of the wall mount and/or of the main body and/or of at least one auxiliary body. Typically, backsplashes comprise gaps between the individual tiles, which form a straight grid. In this case, the gaps extend horizontally and vertically. The optional configuration of the wall mount in such a way that it comprises at least two securing points extending on a straight line means that said securing points can be fixed to the wall so as to be flush with a gap extending in a straight line. Optionally, the straight line of the at least two securing points is oriented vertically in the final mounting state, such that a main extension axis of the wall mount and/or of the main body and/or of the at least one auxiliary body has a horizontal orientation.

The wall mount can for example comprise an adapter, wherein the adapter comprises a receiving portion for receiving the main body in a force-fitting and/or form-fitting and/or integral manner, and a securing portion. The securing portion serves for securing the adapter to a wall in a force-fitting and/or form-fitting and/or integral manner. The main body is preferably connected or secured, or can be secured, to a wall exclusively via the adapter. It is possible that the adapter is connectable to a wall via an, in particular single, force-fitting or form-fitting connection. Optionally, the adapter can be connectable or connected to the wall by means of an integral connection (e.g. using adhesive), in addition to the, in particular single, force-fitting or form-fitting connection.

All the advantages, details, embodiments and/or features of the wall mount according to the invention are transferrable or to be applied to the arrangement according to the invention and to the method according to the invention, and vice versa.

The invention is explained in greater detail with reference to embodiments in the drawings, in which:

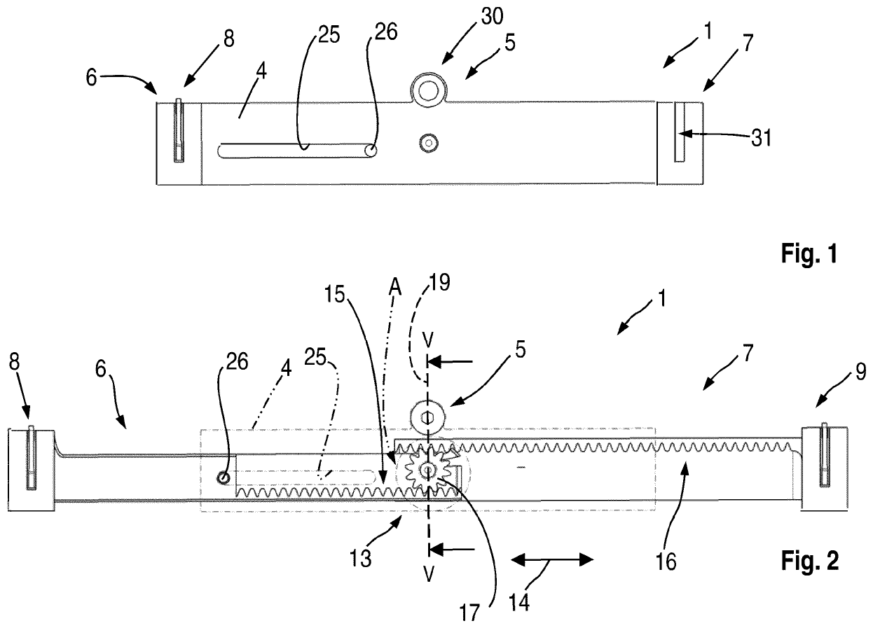

FIG. 1 is a schematic view of a wall mount in the state when pushed together, according to an embodiment;

FIG. 2 is a schematic view of a wall mount in the state when pulled apart, according to an embodiment;

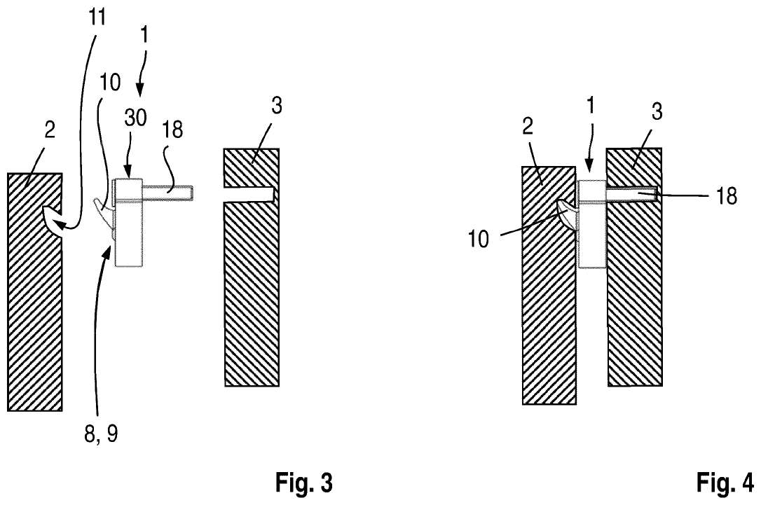

FIG. 3 is a schematic exploded view of an object that to be held on a wall by means of the wall mount;

FIG. 4 is a schematic view of an object that to be held on a wall by means of the wall mount;

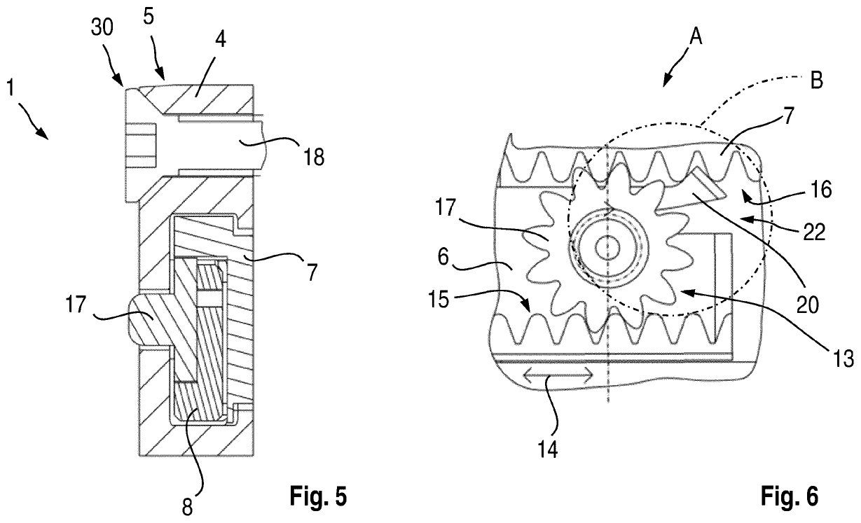

FIG. 5 is a schematic full sectional view of a wall mount according to the cutting line V-V from FIG. 2;

FIG. 6 is a schematic detail view according to detail A from FIG. 2;

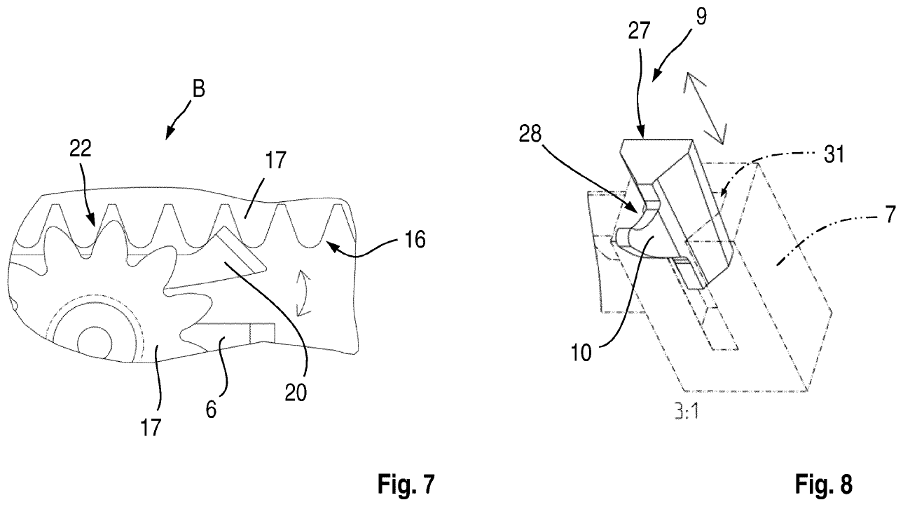

FIG. 7 is a schematic detail view according to detail B from FIG. 6;

FIG. 8 is a schematic perspective view of a holding structure according to an embodiment;

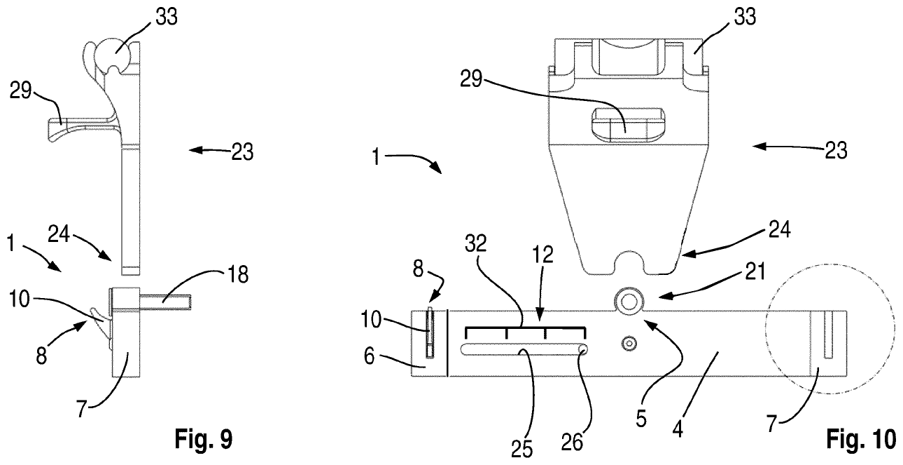

FIG. 9 is a schematic side view from the left of an arrangement comprising a wall mount and a levelling device according to FIG. 10;

FIG. 10 is a schematic front view of an arrangement comprising a wall mount and a levelling device according to an embodiment;

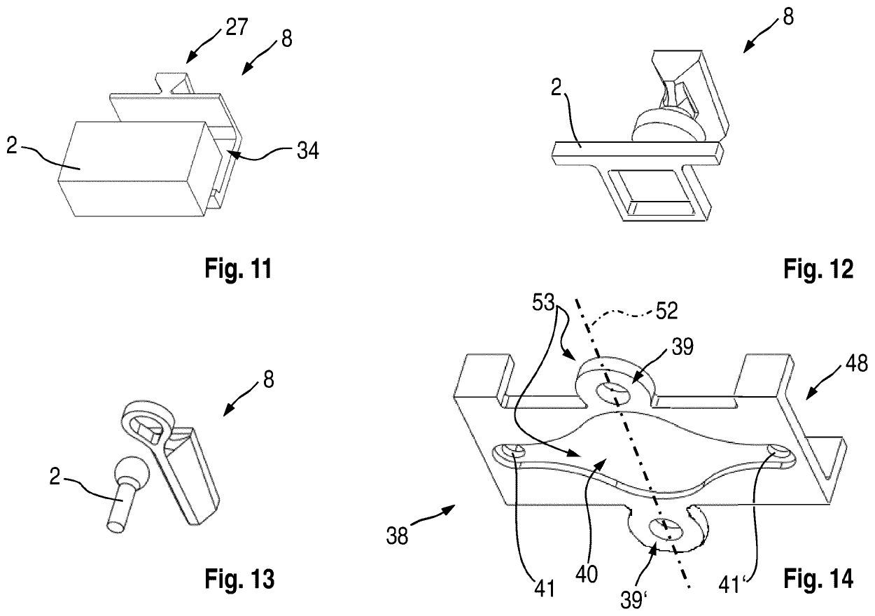

FIGS. 11 to 13 are schematic perspective views of holding structures of different embodiments;

FIG. 14 is a schematic perspective view of an adapter comprising two securing lugs for receiving a main body, according to an embodiment;

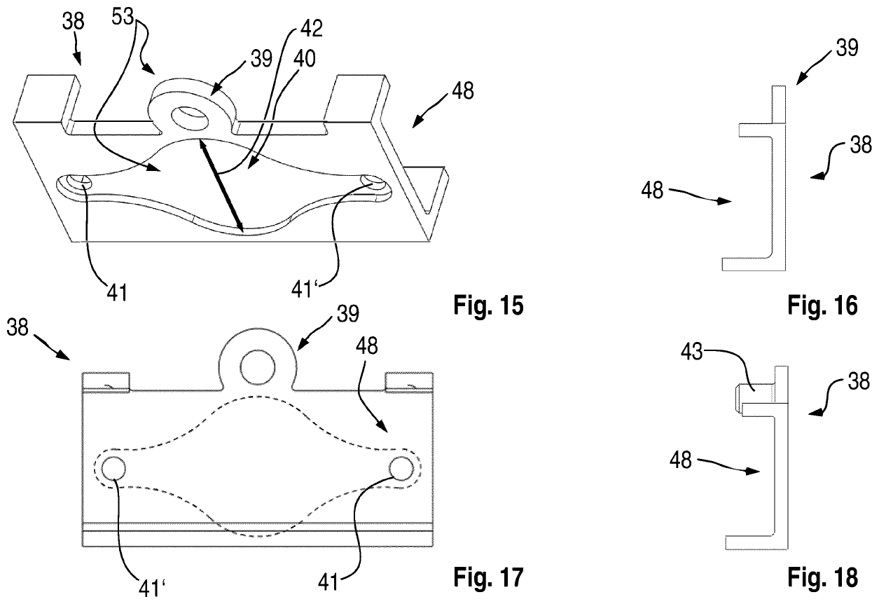

FIG. 15 is a schematic perspective view of an adapter comprising one (single) securing lug for receiving a main body, according to an embodiment;

FIG. 16 is a schematic side view of an adapter according to FIG. 15;

FIG. 17 is a schematic front view of an adapter according to FIG. 15;

FIG. 18 is a schematic perspective view of an adapter comprising a securing pin for receiving a main body, according to an embodiment;

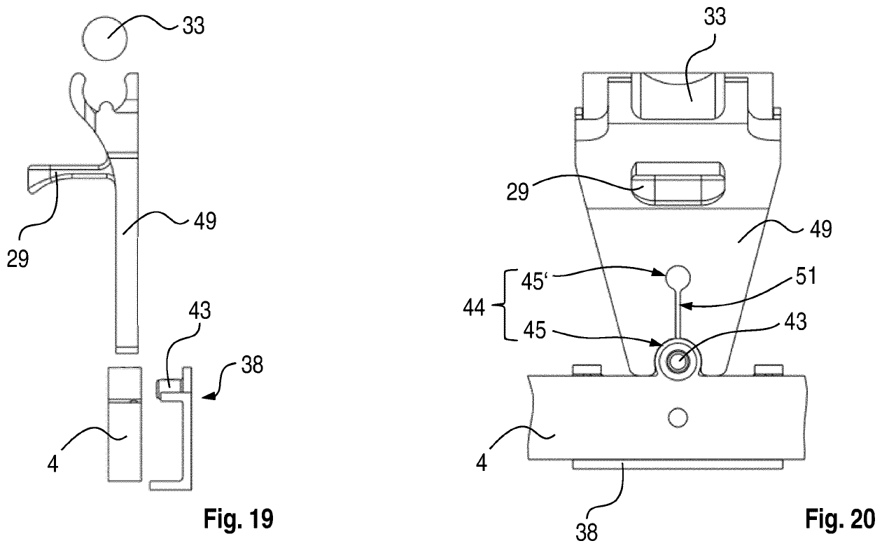

FIG. 19 is a schematic side view from the left of a dismantled arrangement comprising a levelling device and a wall mount having an adapter for receiving the main body according to FIG. 20;

FIG. 20 is a schematic front view of an assembled arrangement comprising a levelling device and a wall mount having an adapter for receiving the main body, according to an embodiment;

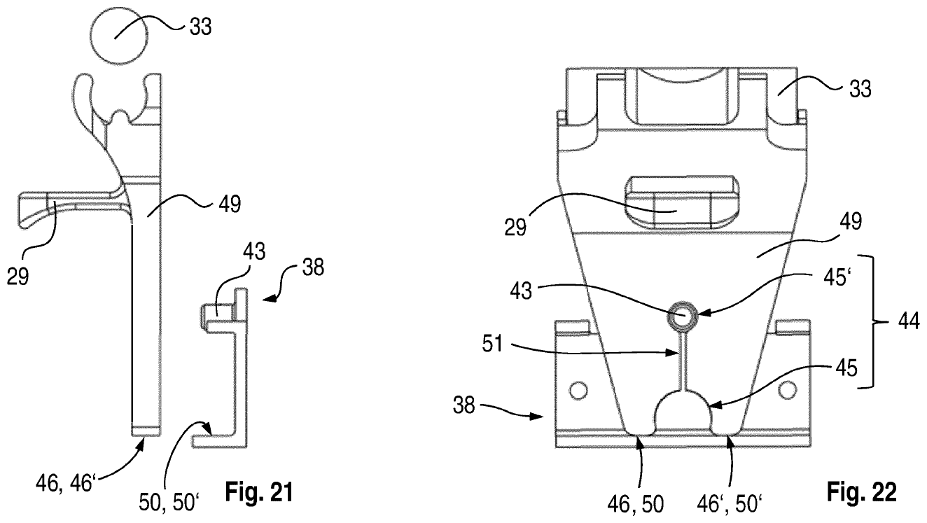

FIG. 21 is a schematic side view from the left of a dismantled arrangement comprising a levelling device and a wall mount having an adapter for receiving the main body according to FIG. 22;

FIG. 22 is a schematic front view of an assembled arrangement comprising a levelling device and an adapter for receiving the main body, according to an embodiment;

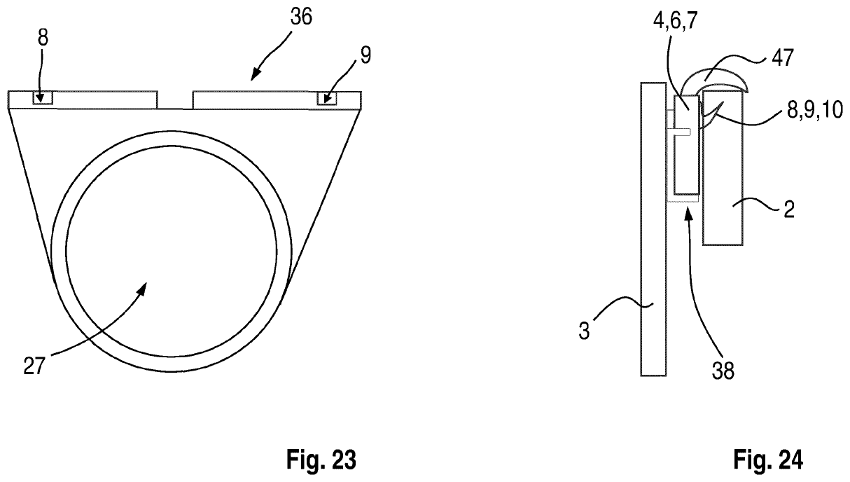

FIG. 23 is a schematic plan view of a holding device provided with a holding structure;

FIG. 24 is a schematic side view of an object secured to a wall by means of the wall mount.

The figure show a wall mount 1 for holding an object 2 on a wall 3 3, comprising (a) a main body 4 having at least one securing structure 5 for securing the wall mount 1 to a wall 3. In this case, the securing structure can be configured in the manner of a receptacle for receiving a securing means 18, e.g. as a lug 30 or recess.

The wall mount 1 further comprises at least two auxiliary bodies 6, 7 which are mounted movably on the main body 4 and each have at least one holding structure 8, 9 for holding an object 2 on the wall securing 1, wherein the at least two holding structures 8, 9 are mounted on the main body 4 via the auxiliary bodies 6, 7 so as to each be movable relative to the securing structure 5. In FIG. 1, the auxiliary bodies 6, 7 are shown in their inserted state, and in FIG. 2 in their maximally extended state, in each case relative to a main body 4. The main body 4 is shown in FIG. 1; in FIG. 2 the main body 4 is indicated only schematically by a dot-dashed line, in order to make the elements and structures arranged inside the main body 4 visible.

It can be seen that the main body 4 has a recess, configured as a slot 25, alternatively as a longitudinal groove (not shown), for receiving a mating element, e.g. in the form of a pin 26, formed or arranged on at least one auxiliary body 6, 7. As can be seen in FIGS. 1 and 2, the slot 25 and pin 26 act as a movement limitation, in particular as an end position limitation, for the movement 14 of the auxiliary bodies 6, 7 relative to one another and/or for the movement 14 of at least one auxiliary body 6, 7, in particular all the auxiliary bodies 6, 7 of a wall mount 1, relative to the main body 4.

At least one holding structure 8, 9, in particular all the holding structures 8, 9, of the wall mount 1 can be connected or connectable to the object 2 by means of a force-fitting and/or form-fitting and/or integral connection. FIGS. 3 and 4 show how an object 2 is connected to the wall mount 1 by means of a securing configured as a hook means 10, and via the fixing of the wall mount 1 by a securing means 18, to a wall 3. For this purpose, the securing means 18 can for example be configured as a screw, which is screwed into a wall 3 provided with a wall plug (not shown), wherein the screw is guided through a lug 30 on the wall mount side.

At least one holding structure 8, 9, in particular all the holding structures 8, 9, of the wall mount 1 can be configured as hook means 10 for hooking into at least one hook receptacle 11 of the object 2.

At least one holding structure 8, 9, in particular all the holding structures 8, 9, of the wall mount 1 can be detachably securable in or on the auxiliary bodies 6, 7. As is shown by way of example in FIG. 8, an auxiliary body 6, 7 can comprise a receptacle 31, into which the holding structure 8, 9 is insertable. For example, the holding structure 8, 9 comprises a holding or hook portion 28 comprising a hook, and a connecting portion 27 provided for being received in the receptacle 31 on the auxiliary body side. The connecting portion 27 of the holding structure 8, 9 can be of a shape that tapers towards the bottom end, such that for example a clamping connection can be achieved. The tapering shape of the connecting portion 27 of the holding structure 8, 9 can also interact with a corresponding shape of the auxiliary body-side receptacle 31 in a centering manner while these are being moved together and/or in a clamping manner at least in the end position.

The at least two auxiliary bodies 6, 7 can be mounted in or on the main body 4 so as to be for example, in particular exclusively, linearly movable, cf. FIGS. 1, 2 and 5. It can be seen from this that the auxiliary bodies 7, 8 are mounted in an linearly movable manner within the main body 8 by rail-like guide portions of the main body 4. In this case, the main body 4, viewed in cross-section (cf. FIG. 5), defines or delimits an interior space within which the two auxiliary bodies 7, 8 are received at least in part, preferably largely. Furthermore, a gearwheel 17 is rotatably mounted in said interior space, in particular on the main body 4. At least one auxiliary body 7, 8, preferably both auxiliary bodies 7, 8, can describe an L-shape in cross-section, wherein the second auxiliary body 8 and/or a gearwheel 17 is or can be arranged in the surface portion of the first auxiliary body 7 defined by the two L-limbs in cross-section. The second auxiliary body 8 can receive the gearwheel 17 at least in portions, in the surface portion defined by its two L-limbs in cross-section, cf. FIG. 5. The gearwheel 17 can for example comprise a bearing journal which is formed integrally with the gearwheel 17 and which is rotatably received in a bearing recess of the main body 4, cf. FIG. 5.

The position and/or orientation of at least one auxiliary body 6, 7, preferably all of the auxiliary bodies 6, 7, relative to the main body 4 can be able to be displayed using a display device 12. The display device 12 can thus provide the user of the wall mount 1, for example by means of a scale 32, with information relating to the position and/or orientation of at least one auxiliary body 6, 7 relative to the main body 4. For example, a scale 32 is arranged or formed in the region of the slot 25, wherein the relative position of the pin 26 with respect to the scale 32 can provide an indication of the extent to which the at least one auxiliary body 6, 7 is pulled out, cf. FIG. 10. Since in the embodiment shown both auxiliary bodies 6, 7 are in each case coupled in their mobility, relative to the main body 4, by means of a positive mechanism, reading out a scale value relating to the position of a pin 26 which is secured to or associated with exclusively one single auxiliary body 6 also provides a statement relating to the relative position of the second auxiliary body 7 relative to the main body 4 and/or relative to the first auxiliary body 6. The scale 32 can relate to a numerical value, e.g. spacing values. Alternatively or in addition, the scale value can give an indication of an object 2 to be secured using the wall mount 1 and/or of the type and/or quality of the object 2 to be secured. Thus, a user of the wall mount 1 can implement the wall mount 1 by a defined movement, visually assisted by the scale 32 or by a marking, of the auxiliary body or bodies 6, 7 relative to the main body 4, depending on the object 2 to be held by the wall mount 1 and/or the quality of said object.

The at least two auxiliary bodies 6, 7 can be coupled to the main body 4 via a control mechanism 13, for example in such a way that the two auxiliary bodies 6, 7 assume a predefined position relative to the main body 4 at least in portions, in particular completely, during their movement 14 relative to the main body 4, in the manner of positive control. In other words, the control mechanism 13 makes it possible that the at least two auxiliary bodies 6, 7 can assume only defined distance ratios with respect to the main body 4.

In this case, the control mechanism 13 can for example control the mobility or the movement 14 of the auxiliary bodies 6, 7 relative to the main body 4 in such a way that a center of gravity of the wall mount 1 based on a longitudinal extension of the wall mount 1 changes by at most 15%, preferably at most 10%, particularly preferably at most 5%, most preferably does not change, provided there is a displacement or pulling out or moving in of the auxiliary bodies 6, 7 relative to the main body 4.

Alternatively or in addition, the control mechanism 13 can comprise a tooth flank surface 15, 16 on each of the auxiliary bodies 6, 7, and a gearwheel 17 that meshes with the tooth flank surfaces 15, 16 of the auxiliary bodies 6, 7 and is rotatably mounted on the main body 4. In the embodiment shown in FIG. 2, the engagement of the gearwheel 17 with the tooth flank surfaces 15, 16, and the mounting of the gearwheel 17 in or on the main body 4 leads to a positive control of the movement of the auxiliary bodies 6, 7 relative to the main body 4.

The securing structure 5 can be configured for example as an interface for securing the wall mount 1 to a wall 3 by a securing means 18, in particular by means of a nail or a screw. The securing structure 5 can serve as a feed-through, e.g. a lug 30, that is arranged or formed in the center 19 of the main body 4 and is intended for receiving a securing means 18, e.g. a screw.

The securing structure 5 can for example (a) be arranged and/or configured as an interface arranged or formed centrally over the longitudinal extension of the main body 4, and/or (b) be arranged or configured as interfaces (not shown) on both sides of a center 19 of a longitudinal extension of the main body 4 and having the same spacing from the center 19. In other words interfaces, i.e. e.g. lugs 30, can be arranged or formed for example so as to be mirror-symmetrical, in particular mirror-symmetrical to the center 19 of the main body 4. Accordingly, the main body 4 can be fixed to the wall 3 by more than one securing means 18.

As can be seen in FIGS. 2 and 6, for example a clamping and/or latching means 22 can be provided, which acts in a clamping or latching manner on a movement 14 of at least one auxiliary body 6, 7 relative to the main body 4. The clamping and/or latching means 22 can accordingly lock a mobility of at least one of the auxiliary bodies 6, 7 relative to a main body 4, or allow it to be performed only after a predefined holding force is overcome. For this purpose, a latching finger 20 can protrude in a latching manner into intermediate spaces of the tooth flank surface 15, 16 of an auxiliary body 6, 7.

For example, the latching finger 20 is associated with a first auxiliary body 6, in particular configured as an integral component of the material of the first auxiliary body 6. In this case, said latching finger 20 can interact with the tooth flank surface 16 of the second auxiliary body 7 or engage in its intermediate spaces. Accordingly, the tooth flank surface 16 of the second auxiliary body 7 can assume a dual function; (a) a function meshing with the gearwheel 17, and (b) a function interacting with the latching finger 20.

FIGS. 9 and 10 show an arrangement comprising a wall mount 1 described herein and a levelling device 23. The levelling device 23 can comprise a connection interface 24, by means of which the levelling device 23 can be connected to the wall mount 1 in a predefined position and orientation relative to the wall mount 1, in particular in a force-fitting and/or form-fitting manner. For this purpose, the wall mount 1 can comprise a mating connection interface 21 which corresponds to the connection interface 24 of the levelling device 23. In the connected state of the connection interface 23 and mating connection interface 21, this connection can be configured such that support of the wall mount 1 by holding the levelling device 23 can be implemented. In other words, the connection between the levelling device 23 and wall mount 1 is configured such that it can bear at least the dead load of the wall mount 1, without the connection being released. For example, this can be made possible by a force-fitting and/or form-fitting connection e.g. by a snap fit connection. The levelling device 23 can for example comprise a level 33 that is detachably or non-detachably secured to a main support of the levelling device 23. The connection interface between the wall mount 1 and levelling device 23 can for example be configured such that the wall mount 1 and levelling device 23 can be put together only in a defined, single orientation relative to one another. Preferably, the levelling device 23 and wall mount 1 can be put together, in particular exclusively, such that the longitudinal axis of a level 33 on the levelling device side and the longitudinal axis of at least one auxiliary body 6, 7 and/or at least one main body 4 are oriented in parallel with one another.

The invention also relates to a method for mounting an object 2 on a wall 3 using a wall mount 1 described herein and/or using an arrangement described herein. In this case, the method can for example provide that, in a first method step, the levelling device 23 is connected to the wall mount 1. Then the wall mount 1, together with the levelling device 23, can be positioned or placed on the wall 3. In this case, it may prove to be expedient if the levelling device 23 comprises a handle 29, by means of which the levelling device 23 and in particular a wall mount 1 connected to the levelling device 23 can be carried or handled. After the levelling device 23 and wall mount 1 have been positioned on the wall 3 and the wall mount 1 has been levelled, the wall mount 1 can be secured by a securing means 18, e.g. a screw, which is guided through the lug 30 and is connected to the wall 3. After the wall mount 1 has been secured to the wall 3 by the securing means 18, the levelling device 23 can be detached from the wall mount 1. Finally, at least one auxiliary body 6, 7, in particular both auxiliary bodies 6, 7, can be moved relative to the main body 4, in order to adjust the spacing of the first and second holding structure 8, 9, in particular the hook means 10, relative to one another to the requirements for connecting an object 2 to the wall mount 1. The movement or adjustment of the auxiliary bodies 6, 7 relative to the main body 4 can take place before and/or during and/or after the securing of the wall mount 1 to the wall 3.

Preferably, the securing structure 5 of the wall mount 1 comprises a single interface or a single securing point for securing the wall mount 1 to a wall 3, cf. FIGS. 1 to 4, 9, 15 to 17. The single interface or the single securing point is configured as a lug 30.

FIGS. 11 to 13 show further optional embodiments of holding structures 8, 9. The holding structure 8 shown in FIG. 11 comprises a locating portion 34, in particular configured as a locating surface. A mating structure of an object 2 to be secured to the wall mount 1 can be placed on said locating portion 34, in particular lying due to gravity. In particular, the locating portion 34 and mating structure of the object 2 comprise corresponding contact surfaces. A locating plane of a locating portion 34 can be oriented for example at right angles to an insertion or plug-in movement axis of the connecting portion 27 of the auxiliary body 6, 7 that is associated with the locating portion 34.

It is possible for at least one holding structure 8, 9 to be configured to establish a connection with an object 2 by means of magnetic forces. For this purpose, the at least one holding structure 8, 9 can be equipped with or comprise at least one magnet. In this case, the holding structure 8, 9 can hold the object 3 for example exclusively by means of magnetic forces. Alternatively, holding of an object 3 by the holding structure 8, 9 can take place by means of magnetic forces and additionally by means of a form-fitting connection.

In FIG. 12, the holding structure 8, 9 comprises a hook means 10 having a mushroom-head shape. In particular, a central axis and/or an axis of symmetry of the hook means 10 is oriented perpendicularly to a central longitudinal axis and/or a main extension axis of the wall mount 1 and/or of the main body 4 and/or of the auxiliary bodies 6, 7 in the final mounting state of the holding structure 8, 9 on the auxiliary body 6, 7.

It is possible for at least one holding structure 8, 9 to be configured as a recess or to comprise at least one such and to be configured to receive an engagement means on the object side, wherein the engagement means is secured indirectly or directly to the object 2 that is to be secured to the wall 3 by means of the wall mount 1, cf. FIG. 13.

It is possible for a holding device 36 to be secured in the receptacles 31 of the auxiliary bodies 6, 7, wherein the holding device 36 comprises at least two holding structures 8, 9. Preferably, the spacing of the holding structures 8, 9 of the holding device 36 is invariable or variable. In the final mounting state of the holding device 38, at least two holding structures 8, 9 provided on the holding device side are positioned or received in the receptacles 31 of the auxiliary bodies 6, 7. The holding device 36 can for example comprise a receiving recess 37, in which an object 2 that is to be secured to the wall 3 by means of the wall mount 1 can be secured. For example, the object is a plant pot (not shown), wherein the receiving recess 37 is dimensioned such that a plant pot can be received or held therein in a form-fitting manner. The main extension plane of the recess 37 can for example be oriented so as to be at right angles to the main extension plane of the wall 3 and/or the wall mount 1 in the final mounting state.

FIGS. 14 to 18 show adapters 38 which each comprise a receiving portion 48 in or to which a main body 4 can be connected in a force-fitting and/or form-fitting manner, in particular the main body 4 is detachably or non-detachably connected to the adapter 38. For example, the receiving portion 48 encompasses the main body 4 at least in portions on at least two sides, preferably at least in portions on at least three sides. The surface of the adapter 38 delimiting the receiving portion 48 can for example be provided with a detent for latching to a corresponding structure of the main body 4. The encompassing of the main body 4 at least in portions preferably serves for ensuring a defined orientation of the main body 4 and adapter 38. Integrally or in addition, a centering and/or orienting structure can be present or configured on the main body 4 and on the adapter 38, which structure specifies a predefined orientation and positioning of the main body 4 and adapter 38 while the main body 4 and adapter 38 are being put together. A fixing of the main body 4 and adapter 38 can take place for example by means of adhesive bonding and/or by means of a snap fit connection.

Furthermore, the adapter 38 can comprise at least one securing lug 39 for guiding through a securing means 18. In FIG. 14, the adapter 38 comprises two securing lugs 39, 39′, preferably the at least two securing lugs 39, 39′ are oriented perpendicularly to a main extension axis of the wall mount 1 and/or of the main body 4 and/or of the first and/or second auxiliary body 6, 7. When the wall mount 1 is used as intended, the securing lugs 39, 39′ can lie on a vertically extending line, as a result of which, in the case of securing of the wall mount 1 to a backsplash. the securing means 18 guided through the securing lugs 39, 39′ in each case can in each case be secured in the wall 3 in a gap of the backsplash. In other words, the securing structure 5 can for example comprise at least two securing points or two securing interfaces for securing the wall mount 1 to a wall 3, wherein the at least two securing points are located on a common straight line 52, wherein the line 52 is oriented perpendicularly to a main extension axis of the wall mount 1 and/or of the main body 4 and/or of at least one auxiliary body 6, 7, cf. FIG. 14.

An adhesive receiving space 40 is furthermore visible from FIG. 14. Said adhesive receiving space 40 is for example arranged or formed on the side, in particular main extension surface, of the adapter 38 facing the wall 3. Adhesive (not shown) can be arranged in the adhesive receiving space 40, which adhesive allows for an integral connection of the adapter 38 to the wall 3. It is possible for the adhesive receiving space 40 to comprise at least one through-opening 41, 41 which provides a fluid-transmitting connection between the adhesive receiving space 40 and the main body 4 and/or between the adhesive receiving space 40 and a surface of the adapter 38 located at the top, bottom and/or side. For example, the at least one through-opening 41, 41′ opens at a surface of the adapter 38 which, in the final mounting state of the main body 4, is covered and/or contacted at least in portions, preferably largely, particularly preferably completely. Said surface of the adapter 38 is visible in FIG. 17.

The adapter 38 comprises a securing portion 53 for fixing the adapter 38 to a wall 3, in this case the securing portion 53 can be configured as an adhesive receiving space 40 and/or as at least one securing lug 39, 39′.

It is possible for the adapter 38 to comprise an anti-twist means (not shown) at its surface facing the wall 3. The anti-twist means can for example comprise at least one spike or at least one point, wherein the spike and/or point rests on or penetrates into the wall surface in the final mounting state of the adapter, and in this way forms an anti-twist protection of the adapter on the wall surface. The actual securing of the adapter 38 can take place for example by means of a securing means 18 and/or by means of an adhesive, wherein for this purpose the anti-twist means forms a structure between the adapter 38 and the wall 3 that substantially ensures anti-twist protection.

For example, at least two through-openings 41, 41′ are provided, such that a first through-opening 41 can serve for introducing adhesive from the outside into the adhesive receiving space 40, and the second through-opening 41′ can function as a pressure compensation opening. The second through-opening 41′ can also indicate the state when sufficient adhesive has been introduced into the adhesive receiving space 40 through the first through-opening 41, since excess adhesive is visible and/or can escape through the second through-opening 41′.

Optionally, the adhesive receiving space 40 has a different volume or a different cross-sectional area over its longitudinal extension. In particular, the cross-sectional area of the adhesive receiving space 40 can have an enlargement of the passage surface over its longitudinal extension, proceeding from a first through-opening 41 to a second through-opening 41′, cf. arrow 42. Further preferably, proceeding from a passage surface-enlarged portion (see arrow 42), in the further course along the longitudinal extension towards the second through-opening 41′ there may be a reduction of the passage surface, cf. FIG. 15.

In the embodiment according to FIG. 15, both the adapter 38 and the main body 4 each comprise a lug, i.e. lug 30 or securing lug 39, 39′. A securing means 18 can be guided through or engage through these two lugs, in order to fix the wall mount 1 to the wall 3. In addition, the adapter 38 can be provided with an adhesive surface (not shown) on its side facing the wall, such that anti-twist prevention of the wall mount 1 on the wall can be achieved by means of the adapter 38.

FIG. 18 shows an adapter 38 which, instead of a securing lug 39, 39′, comprises a securing protrusion, in particular a securing journal 43, wherein the securing protrusion or the securing journal 43 can be used at least for engagement with a main body-side securing structure 5, i.e. e.g. a lug 30 of the main body 4, which can optionally be used for guiding through a securing means 19 for securing the main body 4 (without adapter 38) to a wall 3. Thus, the lug 30 of the main body 4 can fulfil a dual function, on the one hand as a receiving lug for the securing means 19 when the main body 4 is secured directly to a wall 3 by the securing means 19, and on the other hand, when the main body 4 is fixed to the wall 3 by means of the adapter 38, said receiving lug of the main body 4 can serve for receiving the securing journal 43.

If the adapter 38 comprises a securing protrusion, e.g. a securing journal 43, then at least two options for the arrangement or use of the levelling device 23 can be made possible. For example, the levelling device 23 comprises at least one securing region 44, in particular configured as a receiving opening 45, 45′, for temporarily securing the levelling device 23 to the main body 4 and/or to the adapter 38. In the secured state of the levelling device 23 and main body 4 and/or adapter 38, the level 33 can be used to align the main body 4 or the adapter 38 horizontally.

In the embodiment shown in FIGS. 19 to 22, the levelling device 23 comprises a base body 49 which has a first receiving opening 45 and a further receiving opening 45′. As can be seen in FIG. 20, the first receiving opening 45 can be configured to surround a securing structure 5 of the main body 4 at least in portions. It is possible for the base body-side receiving opening 45 together with a portion of the main body 4, in particular with a structure of the main body 4 that delimits the securing structure 5 externally, to serve as a centering means and/or guide, and optionally additionally to serve for force-fitting and/or form-fitting fixing of the base body 49 and main body 4. For this purpose—as shown in FIG. 20—the levelling device 23 can be arranged in a first position relative to the adapter 38.

In FIG. 22 a second position of the levelling device 23 relative to the adapter 38 is visible; for this, a further interface of the adapter 38, e.g. a further receiving opening 45′, is connected to an adapter-side securing protrusion, in particular to a securing journal 43 of the adapter 38. This connection can for example take place in that, in the assembled state of the levelling device 23 and adapter 38, no relative twisting is made possible. For this purpose, e.g. at least one contact portion 46, 46′ that limits a first receiving opening 45 at least in portions, and/or at least one contact portion 46, 46′ adjoining the first receiving opening 45 can come into contact with a mating contact portion 50, 50′ of the adapter 38. According to the embodiment shown in FIG. 22, the base body 49 comprises two contact portions 46, 46′ which are spaced apart from one another and which, in the assembled state of the levelling device 23 and adapter 38, are in contact with two mating contact portions 50, 50′ of the adapter 38, in order to prevent relative twisting of the levelling device 23 and adapter 38.

It is possible for the connecting recess 51, which in particular extends straight, in the base body 49, to extend at least from the first receiving opening 45 to the second receiving opening 45′. Said connecting recess 51 can establish or support resilient behavior of at least one region delimiting a receiving opening 45, 45′. In particular, the connecting recess can allow for a clip function to a receiving opening 45, 45′ by the purposeful weakening of the structure of the base body 49.

A fixing device 47 is shown in FIG. 24, which holds an object 2, which is to be fixed to a wall 3 via a wall mount 1, in a loss-proof manner or so as not to be unintentionally detachable. In other words, the fixing device 47 allows for a form-fitting and/or force-fitting securing of an object 2 to the main body 4 and/or to the at least one auxiliary body 6, 7 and/or to the at least one adapter 38 in such a way that the object 2 cannot be detached without influence on the fixing device 47. For example, the fixing device 47 is in contact with one end on the main body 4 and/or on at least one auxiliary body 6, 7 and/or on at least one adapter 38, and at the other end with the object 2 to be secured. It is possible for the fixing device 47 to comprise a preload means (not shown) and/or to be configured to be elastically deformable in such a way that the fixing device 47 applies a pressing force to the object. Alternatively or in addition, the fixing device 47 is configured such that it, together with the holding structure 8, 9, surrounds the object 2 to be secured over at least three sides. Optionally, the fixing device 47 can be able to be secured in a detachable, i.e. non-destructively detachable, manner to the main body 4 and/or to at least one auxiliary body 6, 7 and/or to at least one holding structure 8, 9.

### LIST OF REFERENCE SIGNS

1 wall mount
2 object
3 wall
4 main body
5 securing structure
6 first auxiliary body
7 second auxiliary body
8 first holding structure
9 second holding structure
10 hook means
11 hook receptacle
12 display device
13 control mechanism
14 movement
15 tooth flank surface of 6
16 tooth flank surface of 7
17 gearwheel
18 securing means
19 center of 4 or 1
20 latching finger
21 mating connection interface of 1
22 latching device
23 levelling device
24 connection interface of 23
25 slot
26 pin
27 connecting portion of 5
28 holding portion of 5
29 handle of 23
30 lug
31 receptacle of 6, 7
32 scale
33 level
34 locating portion of 8, 9
35 engagement means
36 holding device
37 receiving recess
38 adapter
39, 39′ securing lug of 38
40 adhesive receiving space of 38
41, 41′ through-opening of 38
42 double arrow (region of enlarged passage surface of 40)
43 securing journal of 38
44 securing region of 23
45, 45′ receiving opening of 23
46, 46′ contact portions of 23
47 fixing device
48 receiving portion of 38
49 base body of 23
50, 50′ mating contact portions of 38
51 connecting recess of 38
52 straight line
53 securing portion of 38

1. A wall mount for holding an object on a wall, comprising:
a main body having at least one securing structure for securing the wall mount to a wall, and
at least two auxiliary bodies which are mounted movably on the main body and each have at least one holding structure for holding an object on the wall securing, wherein the at least two holding structures are mounted on the main body via the auxiliary bodies so as to each be movable relative to the securing structure.

2. The wall mount of claim 1, wherein at least one holding structure of the wall mount is or are connected or connectable to the object by means of a force-fitting and/or form-fitting and/or integral connection.

3. The wall mount of claim 1, wherein at least one holding structure of the wall mount is configured as hook means for hooking into at least one hook receptacle of the object.

4. The wall mount of claim 1, wherein at least one holding structure of the wall mount can be detachably secured in or on the auxiliary bodies.

5. The wall mount of claim 1, wherein the at least two auxiliary bodies are mounted in or on the main body so as to be linearly movable.

6. The wall mount of claim 1, wherein the position and/or orientation of at least one auxiliary body relative to the main body can be displayed using a display device.

7. The wall mount of claim 1, wherein the at least two auxiliary bodies are coupled to the main body via a control mechanism in such a way that the two auxiliary bodies assume a predefined position relative to the main body at least in portions during their movement relative to the main body, in the manner of positive control.

8. The wall mount of claim 7, wherein the control mechanism controls the mobility of the auxiliary bodies relative to the main body in such a way that a center of gravity of the wall mount based on a longitudinal extension of the wall mount changes by at most 15%.

9. The wall mount according to claim 7, wherein the control mechanism comprises a tooth flank surface on each of the auxiliary bodies, and a gearwheel that meshes with the tooth flank surfaces of the auxiliary bodies and is rotatably mounted on the main body.

10. The wall mount of claim 1, wherein the securing structure is configured as an interface for securing the wall mount to a wall by a securing means.

11. The wall mount of claim 10, wherein the securing structure:
is arranged or configured as an interface arranged or formed centrally over the longitudinal extension of the main body, and/or
is arranged or configured as interfaces on both sides of a center of a longitudinal extension of the main body and having the same spacing from the center.

12. The wall mount of claim 1, wherein the securing structure is a single interface for securing the wall mount to a wall in a force-fitting and/or form-fitting manner.

13. The wall mount claim 1, wherein the securing structure comprises at least two securing points for securing the wall mount to a wall, in a force-fitting and/or form-fitting manner, wherein the at least two securing points are located on a common straight line, wherein the line is oriented perpendicularly to a main extension axis of the wall mount and/or of the main body and/or of at least one auxiliary body.

14. The wall mount of claim 1, wherein a clamping and/or latching means which acts in a clamping or latching manner on a movement of at least one auxiliary body relative to the main body.

15. The wall mount of claim 1, wherein an adapter comprises a receiving portion for receiving the main body in a force-fitting and/or form-fitting and/or integral manner, and a securing portion which allows for the adapter to be secured to a wall in a force-fitting and/or form-fitting and/or integral manner, the main body is connected to a wall exclusively via the adapter.

16. An arrangement comprising a wall mount of claim 1, and a levelling device, wherein the levelling device comprises a connection interface, by means of which the levelling device can be connected to the wall mount in a predefined position and orientation relative to the wall mount in a force-fitting and/or form-fitting manner.

17. A method for mounting an object on a wall using:
a wall mount for holding an object on a wall, the wall comprising:
a main body having at least one securing structure for securing the wall mount to a wall, and
at least two auxiliary bodies which are mounted movably on the main body and each have at least one holding structure for holding an object on the wall securing, wherein the at least two holding structures are mounted on the main body via the auxiliary bodies so as to each be movable relative to the securing structure; and or the arrangement according to claim 16.
